(19) United States
(12) Patent Application Publication
(10) Pub. No.: US 2025/0229648 A1
(43) Pub. Date: Jul. 17, 2025

(54) BATTERY AND ASSOCIATED ASSEMBLY METHOD

(71) Applicant: AUTOMOTIVE CELLS COMPANY SE, BRUGES (FR)

(72) Inventors: Pierre CHAUVEAU, BRUGES (FR); Alexandre MATHIEU, BORDEAUX (FR); Mathieu QUEYRENS, SAINT-DENIS-DE-PILE (FR); Dimitri MARATHE, VILLENAVE D'ORNON (FR)

(21) Appl. No.: 18/852,058

(22) PCT Filed: Mar. 30, 2023
(86) PCT No.: PCT/EP2023/058230

§ 371 Date: Sep. 27, 2024

(30) Foreign Application Priority Data
Mar. 31, 2022 (EP) 22305415.6

(51) Int. Cl. B60L 50/64; H01M 50/209; H01M 50/271; H01M 50/289; H01M 50/505

(52) U.S. Cl. CPC B60L 50/64; H01M 50/209; H01M 50/271; H01M 50/289; H01M 50/505; H01M 2220/20

(57) ABSTRACT

The invention relates to a battery comprising:
a casing (12) defining a housing,
a plurality of assemblies (16) arranged in the housing, each of the assemblies (16) comprising a plurality of electrochemical cells and defining a first lateral end (38) and a second lateral end opposite one another according to the transverse direction,
at least one electrical connector (20) extending transversely between a first lateral edge (26) of the casing (12) and the first lateral end (38) of at least one of the assemblies (16).

The battery (10) further comprises at least one cover (22) extending according to the longitudinal direction (X) and arranged transversely between the first lateral edge (26) of the casing (12) and the first lateral ends (38) of the assemblies (16), the cover (22) at least partially delimiting a protective housing (24), the electrical connector (20) being housed in the protective housing (24).

The present invention relates to a battery, in particular for a vehicle powered at least in part by an electric battery.

The invention applies in particular to the manufacture of a battery, especially for an electric vehicle. “Battery” means a plurality of electrochemical cells electrically connected to one another. According to a particular example of a battery, the plurality of electrochemical cells is arranged in the form of one or more battery assemblies, each battery assembly comprising several electrochemical cells electrically connected to one another and mechanically assembled to one another by an assembly system, such as assembly plates. In particular, an electrochemical cell comprises a stack of positive electrodes connected to one another and a stack of negative electrodes connected to one another, separated by a separator, known as a “stack”. The positive electrodes, connected to one another, form a positive terminal, and the negative electrodes, connected to one another, form a negative terminal.

Typically, the assemblies are arranged in a casing next to one another and are connected by electrical connectors placed, for example, in a layer in the center of the battery.

However, such an arrangement of connectors reduces the energy density of the battery, in particular due to the addition of this extra layer in the center of the battery, of which a significant part of the volume generally remains empty.

It is also known to arrange the connectors along the lateral ends of the assemblies, but this presents the disadvantage of exposing them in the event of a side impact on the vehicle, with a risk of short-circuiting.

One of the aims of the invention is to overcome these drawbacks and propose a compact battery with good energy density, without increasing the risk of short-circuiting in the event of side impact.

To this end, the invention has as its object a battery comprising:
a casing defining a housing, the casing defining a first lateral edge and a second lateral edge opposite one another according to a transverse direction,
a plurality of assemblies arranged in the housing and extending successively in the longitudinal direction perpendicular to the transverse direction, each of the assemblies comprising a plurality of electrochemical cells extending successively in the transverse direction, each of the assemblies defining a first lateral end and a second lateral end opposite one another according to the transverse direction,
at least one electrical connector extending transversely between the first lateral edge of the casing and the first lateral end of at least one of the assemblies,
the battery further comprising at least one cover extending according to the longitudinal direction and arranged transversely between the first lateral edge of the casing and the first lateral ends of the assemblies, the cover at least partially delimiting a protective housing extending between the cover and a bottom of the casing in a third direction perpendicular to the longitudinal direction and the transverse direction, the electrical connector being housed in the protective housing.

According to particular embodiments, the battery comprises one or more of the following optional features, taken in isolation or in any technically possible combinations:
the electrical connector is an interconnection busbar electrically connecting the first lateral ends of two assemblies to one another;
the cover presents an L-shaped cross-section perpendicular to the longitudinal direction, the cross-section comprising a first leg extending according to the transverse direction and a second leg perpendicular to the first leg and extending according to the third direction;
the second leg of the cover extends against the first lateral edge of the casing;
the protective housing is delimited according to the third direction by the first leg of the cover;
the battery comprises a crossmember extending according to the transverse direction, the crossmember being longitudinally interposed between two assemblies, the crossmember comprising a first lateral end and a second lateral end opposite one another according to the transverse direction;
the battery comprises an angle bracket fixed to the first lateral end of the crossmember, the cover abutting the angle bracket according to the third direction;
the angle bracket comprises a first part extending according to the transverse direction and a second part extending according to the third direction and perpendicular to the first part, the second leg of the cover abutting according to the third direction the first part of the angle and the first leg of the cover abutting according to the transverse direction the second part of the angle;
the second part of the angle is fixed to the first lateral end of the crossmember;
the first lateral edge of the casing comprises a longitudinal rail, the first part of the angle bracket being in plane contact with said longitudinal rail;
the angle bracket comprises a third part parallel to the first part, the first leg of the cover abutting, according to the third direction, the third part of the angle bracket;
the battery comprises a second cover extending, according to, the longitudinal direction and arranged between the second lateral ends of the assemblies and the second lateral edge of the casing.

The invention also has as its object a method of assembling a battery as described above, comprising at least the following steps:
a step of arranging the assemblies in a longitudinal mounting direction to obtain an arranged system,
a step of fixing the assemblies to the casing to obtain a fixed system,
a step of fixing the electrical connector transversely between the first lateral edge of the casing and the first lateral end of at least one of the assemblies, and
a step of fixing the cover, so that it extends transversely between the first lateral edge and the first lateral ends of the assemblies and at least partially delimits the protective housing, the electrical connector being housed in the protective housing.

The invention will be better understood on reading the following description, given only as a non-limiting example, and made with reference to the appended drawings, on which:

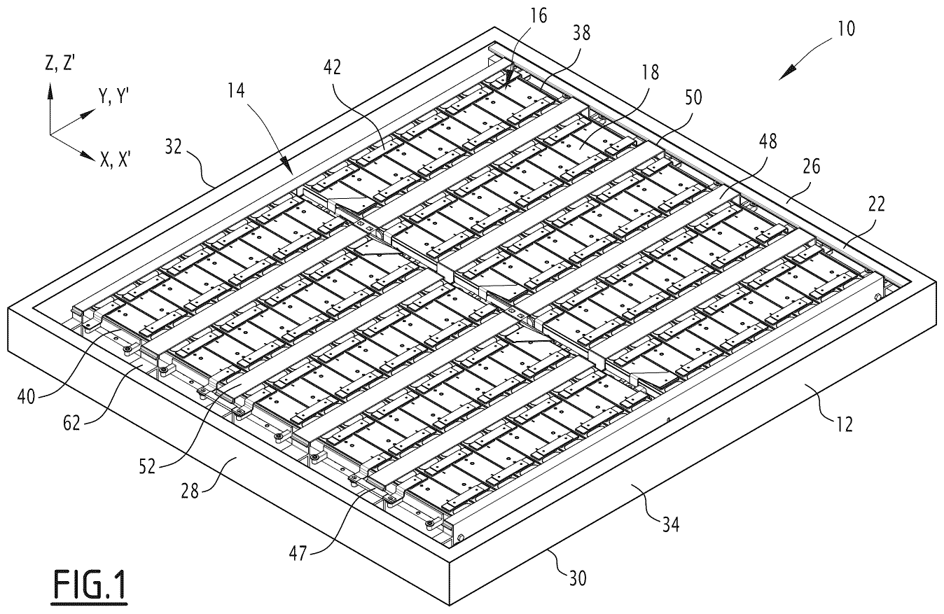

FIG. 1 is a perspective schematic view of a battery according to the invention, comprising a plurality of assemblies, and

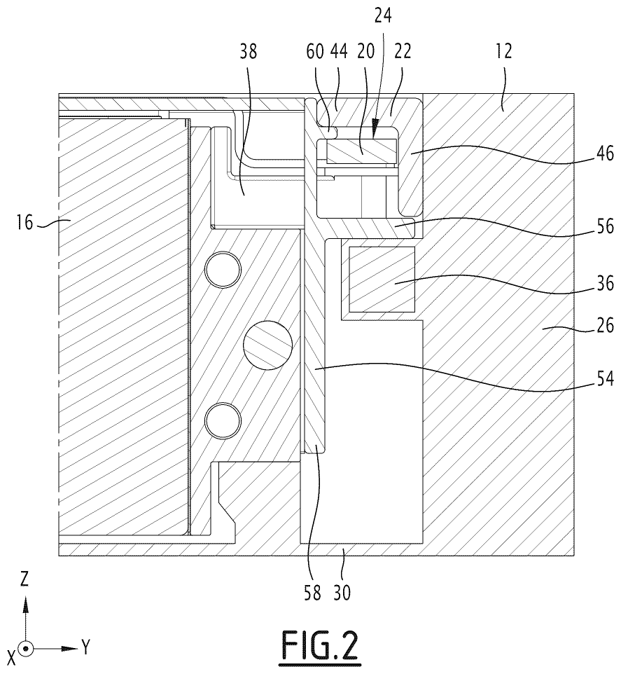

FIG. 2 is a sectional view according to a cross-sectional plane YZ of a first lateral end of the battery shown in FIG. 1.

With reference to FIGS. 1 and 2, a battery 10 according to the invention is described.

The battery 10, which is shown in part in FIG. 1, is intended, for example, for installation in an electric or hybrid motor vehicle (not shown).

The battery 10 comprises a casing 12 defining a housing 14 extending in a longitudinal direction X which is, for example, the direction of forward travel of the vehicle, and in a transverse direction Y perpendicular to the longitudinal direction and which is, for example, the transverse direction of the vehicle.

A third direction Z is also defined which is perpendicular to the longitudinal direction X and the transverse direction Y, and which is intended to be substantially vertical, for example, when the vehicle is located on a horizontal surface (not shown).

The battery 10 further comprises a plurality of assemblies 16 arranged in the housing 14 and extending successively in the longitudinal direction X, each of the assemblies 16 includes electrochemical cells 18 extending successively in the transverse direction Y and secured to one another.

The battery 10 also comprises at least one electrical connector 20 and a cover 22 at least partially delimiting a protective housing 24, the electrical connector 20 being housed in the protective housing 24.

The battery 10 advantageously comprises at least one second electrical connector 47 and a second cover (not shown).

Preferably, the battery 10 further comprises at least one crossmember 48 extending in the transverse direction Y, the crossmember 48 comprising a first lateral end 50 and a second lateral end 52 opposite one another according to the transverse direction Y.

In the example illustrated in FIG. 1, the battery 10 comprises five assemblies 16 and six crossmembers 48. Four of the six crossmembers 48 are longitudinally interposed between the assemblies 16, and two crossmembers 48 are said to be longitudinally “extremal”, as they run along only one of the assemblies 16 respectively.

According to other embodiments, not shown, the number of assemblies 16 is less than five or more than five, and the number of crossmembers 48 is less than six or more than six.

The battery 10 further comprises at least one angle bracket 54 fixed to the first lateral end 50 of the crossmember48 and to the casing 12.

Preferably, the battery 10 further comprises at least one second angle bracket 62 fixed to the second lateral end 52 of the crossmember 48 and to the casing 12.

The battery 10 also includes fixing members (not shown), such as screws, for securing the assemblies 16 to the casing 12.

The casing 12, for example, presents a parallelepiped shape, advantageously flattened in the third direction Z, as the battery 10 is for example intended to be integrated in the lower part of the vehicle, for example under a passenger compartment.

The casing 12 defines a first lateral edge 26 and a second lateral edge 28 opposite one another according to the transverse direction Y. The casing further comprises a bottom 30, and a third lateral edge 32 and a fourth lateral edge 34 opposite one another in the longitudinal direction X.

The first lateral edge 26 of the casing 12 advantageously comprises a longitudinal rail 36 projecting transversely in the direction of the second lateral edge 28.

Each of the assemblies 16 defines a first lateral end 38 and a second lateral end 40 opposite one another according to the transverse direction Y.

As illustrated in FIG. 2, the first lateral end 38 of each of the assemblies 16 is spaced from the first lateral edge 26 of the casing 12.

Advantageously, each of the assemblies 16 also comprises electrical connectors 42 for connecting the cells 18 to one another.

The crossmember 48 extends, for example, in the transverse direction Y between the first lateral edge 26 and the second lateral edge 28 of the casing 12.

Preferably, the crossmember 48 is inserted longitudinally between two assemblies 16.

In the example illustrated in FIG. 1, the crossmembers 48 and the assemblies 16 are advantageously arranged successively in the housing 14 one against the other in the longitudinal direction X and in an alternating manner, the assemblies 16 and crossmembers 48 being fixed to the casing 12.

Alternatively, (not illustrated), the crossmembers 48 and the assemblies 16 are arranged in the longitudinal direction X with mechanical clearance between the crossmembers 48 and the assemblies 16.

Preferably, the angle bracket 54 comprises a first part 56 extending according to the transverse direction Y and a second part 58 extending according to the third direction Z and perpendicular to the first part 56.

Advantageously, the angle bracket 54 further comprises a third part 60 parallel to the first part 56.

The angle bracket 54 is able to transmit transverse forces between the crossmember 48 and the casing 12.

In particular, the second part 58 of the angle bracket 54 is fixed to the first lateral end 50 of the crossmember 48, for example by welding or gluing.

In addition, the first part 56 of the angle bracket 54 is, for example, in planar contact with the longitudinal rail 36, and more particularly is, for example, fixed by screws thereto.

The electrical connector 20 extends transversely between the first lateral edge 26 of the casing 12 and the first lateral end 38 of the at least one of the assemblies 16.

In particular, the electrical connector 20 is arranged on the side of the longitudinal rail 36 opposite the bottom 30 of the casing 12 according to the third direction Z.

For example, the electrical connector 20 is arranged between two assemblies 16 to electrically connect them together.

More specifically, the electrical connector 20 is a busbar, for example made of copper or aluminum, electrically connecting the first lateral ends 38 of two assemblies 16 with each other.

The cover 22 extends according to the longitudinal direction X and is arranged transversely between the first lateral edge 26 and the first lateral ends 38 of the assemblies 16.

According to the invention, the cover 22 is able to transmit transverse forces between the assemblies 16 and the casing 12, in such a way that the protective housing 24 is less sensitive to deformation in the event of a side impact on the vehicle.

Advantageously, the cover 22 abuts, according to the third direction Z, the angle bracket 54.

The cover 22 preferably presents an L-shaped cross-section perpendicular to the longitudinal direction, the cross-section comprising a first leg 44 extending according to the transverse direction Y and a second leg 46 perpendicular to the first leg 44 and extending according to the third direction Z.

As illustrated in FIG. 2, the second leg 46 of the cover 22 preferably extends against the first side edge 26 of the housing 12.

More particularly, the second leg 46 of the cover 22 abuts the first part 56 of the angle bracket 54 according to the third direction Z.

Advantageously, the first leg 44 of the cover 22 abuts the second part 58 of the angle bracket 54 according to the transverse direction Y.

Furthermore, the first leg 44 of the cover 22 advantageously abuts the third part 60 of the angle bracket 54 according to the third direction Z, which allows the cover 22 to be held securely in position.

As illustrated in FIG. 2, the protective housing 24 extends in the third direction Z between the cover 22 and the bottom 30 of the casing 12.

Advantageously, the protective housing 24 is delimited according to the third direction Z by the first leg 44 of the cover 22.

More particularly, the protective housing 24 extends according to the third direction Z between the first leg 44 of the cover 22 and the longitudinal rail 36.

As illustrated in FIG. 2, the protective housing 24 is preferably delimited according to the third direction Z between the first leg 44 of the cover 22 and the first part 56 of the angle bracket 54.

The second electrical connector 47 advantageously extends transversely between the second lateral edge 28 of the casing 12 and the second lateral end 40 of at least one of the assemblies 16.

The second cover (not shown) extends according to the longitudinal direction X and is arranged between the second lateral ends 40 of the assemblies 16 and the second lateral edge 28 of the casing 12.

The second cover is substantially identical to the cover 22 described above and also partially delimits a protective housing for the second electrical connector 47.

Advantageously, the second cover abuts the second angle bracket 62 according to the third direction Z.

A method for assembling the battery 10 according to the invention will now be described.

The method comprises a step of arranging the assemblies 16 in a longitudinal mounting direction X′ to obtain an arranged system, and a step of fixing the assemblies 16 to the casing 12 to obtain a fixed system.

In the arranged system, the electrochemical cells 18 of each of the assemblies 16 extend successively in the transverse mounting direction Y″.

The fixed system is located in the housing 14 and oriented relative to the casing 12 so that the clamping direction X′ is parallel to the longitudinal direction X defined by the battery 10 in the assembled state, and the transverse mounting direction Y′ is parallel to the transverse direction Y defined by the battery 10 in the assembled state.

Preferably, the method comprises a supplementary step of arranging at least one crossmember 48 and a step of clamping the crossmember(s) 48 and the assemblies 16 one against the other in the longitudinal mounting direction X′.

Each angle bracket 54 is fixed, for example by welding, to the first lateral end 50 of the corresponding crossmember 48.

In the method, the assemblies 16 are advantageously arranged in the housing 14. The longitudinal mounting direction X′ is parallel to the longitudinal direction X, and the transverse mounting direction Y′ is parallel to the transverse direction Y as of the arrangement stage.

The angle bracket(s) 54 is (are) for example screwed to the first lateral edge 26 of the casing 12, and more particularly screwed to the longitudinal rail 36. Thus, the crossmember(s) 48 are advantageously fixed by means of the angle bracket(s) 54.

The method then comprises a step of fixing the electrical connector 20, for example, a connection bar, transversely between the first lateral edge 26 of the casing 12 and the first lateral end 38 of at least one of the assemblies 16.

The method comprises a step of fixing the cover 22, so that it extends transversely between the first lateral edge 26 and the first lateral ends 38 of the assemblies 16 and at least partially delimits the protective housing 24.

Preferably, the cover 22 is placed on the angle bracket(s) 54 and is then advantageously fixed to the casing 12, by screws for example.

Thanks to the features described above, the battery 10 according to the invention is a compact battery with good energy density, while reducing the risk of short-circuiting in the event of side impact.

Indeed, the protective housing 24 delimited in part by the cover 22 allows some of the electrical connectors to be routed not in the center of the battery, but alongside it, with a much smaller loss of energy storage volume.

The electrical connectors 20 thus positioned are protected in the protective housing 24, which is less sensitive to deformation thanks to the transverse forces taken up by the cover 22 and possibly the angle bracket(s) 54.

The invention is not limited to the example embodiments and alternatives described above and illustrated in the drawings.

For example, according to one alternative of the invention, the battery 10 comprises a plurality of covers 22 extending side by side according to the longitudinal direction X, and not a single cover 22 extending over the entire length of the casing 12 in the longitudinal direction X.

1. A battery comprising:
a casing defining a housing, the casing defining a first lateral edge and a second lateral edge opposite one another according to a transverse direction,
a plurality of assemblies arranged in the housing and extending successively in the longitudinal direction perpendicular to the transverse direction, each of the assemblies comprising a plurality of electrochemical cells extending successively in the transverse direction, each of the assemblies defining a first lateral end and a second lateral end opposite one another according to the transverse direction,
at least one electrical connector extending transversely between the first lateral edge of the casing and the first lateral end of the at least one of the assemblies,
wherein the battery further comprises at least one cover extending according to the longitudinal direction and arranged transversely between the first lateral edge of the casing and the first lateral ends of the assemblies,
the cover at least partially delimiting a protective housing extending between the cover and a bottom of the casing in a third direction perpendicular to the longitudinal direction and the transverse direction, the electrical connector being housed in the protective housing.

2. The battery according to claim 1, wherein the electrical connector is an interconnection busbar electrically connecting the first lateral ends of two assemblies to one another.

3. The battery according to claim 1, wherein the cover presents an “L”-shaped cross-section perpendicular to the longitudinal direction, the cross-section comprising a first leg extending, according to, the transverse direction and a second leg perpendicular to the first leg and extending according to the third direction.

4. The battery according to claim 3, wherein the second leg of the cover extends against the first lateral edge of the casing.

5. The battery according to claim 3, wherein the protective housing (24)is delimited according to the third direction by the first leg of the cover.

6. The battery according to claim 3, comprising at least one crossmember extending according to the transverse direction, the crossmember being interposed longitudinally between two assemblies, the crossmember comprising a first lateral end and a second lateral end opposite one another according to the transverse direction.

7. The battery according to claim 6, comprising at least one angle bracket fixed to the first lateral end of the crossmember, the cover abutting the angle bracket according to the third direction.

8. The battery according to claim 7, wherein the angle bracket comprises a first part extending according to the transverse direction and a second part extending according to the third direction and perpendicular to the first part, the second leg of the cover abutting, according to, the third direction the first part of the angle bracket and the first leg of the cover abutting, according to the transverse direction the second part of the angle bracket.

9. The battery according to claim 8, wherein the second part of the angle bracket is fixed to the first lateral end of the crossmember.

10. The battery according to claim 8, wherein the first lateral edge of the casing comprises a longitudinal rail, the first part of the angle bracket being in planar contact on said longitudinal rail.

11. The battery according to claim 8, wherein the angle bracket comprises a third part parallel to the first part, the first leg of the cover abutting, according to the third direction, the third part of the angle bracket.

12. The battery according to claim 1, comprising a second cover extending according to the longitudinal direction and arranged between the second lateral ends of the assemblies and the second lateral edge of the casing.

13. A method for assembling a battery according to claim 1, comprising:
a step of arranging the assemblies in a longitudinal mounting direction to obtain an arranged system,
a step of fixing the assemblies to the casing to obtain a fixed system,
a step of fixing the electrical connector transversely between the first lateral edge of the casing and the first lateral end of at least one of the assemblies, and
a step of fixing the cover, so that it extends transversely between the first lateral edge and the first lateral ends of the assemblies and at least partially delimits the protective housing, the electrical connector being housed in the protective housing.
